(19) United States
(12) Patent Application Publication
(10) Pub. No.: US 2016/0310767 A1
(43) Pub. Date: Oct. 27, 2016

(54) Belay Device

(71) Applicant: OBERALP SPA, Bozen (IT)

(72) Inventors: Egon Resch, Bozen (IT); Christoph Baumgartner, Bruneck (IT)

(21) Appl. No.: 15/134,692

(22) Filed: Apr. 21, 2016

(30) Foreign Application Priority Data
Apr. 22, 2015 (DE) 10 2015 207 363.7

(51) Int. Cl. A62B 1/14

(52) U.S. Cl. CPC A62B 1/14

(57) ABSTRACT

The present invention concerns a belay device, which is characterized by particularly safe handling. The invention provides a belay device (2), comprising a braking device (6) and a blocking device (8), whereby the blocking device (8) comprises a movable rope holding element (12, 14), which is designed to be moved by a rope (16) being held on it, whereby the blocking device (8) is designed in a blocking state to block a movement of the rope holding element (12), whereby in a securing case the blocking device (8) transitions into the blocking state, whereby a securing case exists when a movement parameter of the movement of the rope holding element (12, 14) of a movement parameter set lies outside a predetermined safety range of the movement parameter assigned to the respective movement parameter.

The present invention concerns a belay device comprising a braking device and a blocking device.

Over the last decade, climbing has developed into a popular sport, in which climbing and safety techniques are increasingly learned by the climbers themselves without expert guidance. This leads, in particular in emergency situations, to mishandling of the safety equipment and results in serious injuries to the climbers. The safety equipment can also be handled incorrectly, with the same results, by an experienced climber in a panic situation, or if consciousness is lost.

In this context, securing with a Munter hitch and securing with a figure eight descender have proven to be particularly error-prone. In particular for inexperienced climbers, it happens again and again that a finger is pulled into the belaying knot or under the belaying rope and, if the belayer then releases the belaying rope, the rope can slide through the belay device at great speed, exposing the climber is to a high risk of injury. For the figure eight descender in particular, there is a possibility that the rope is threaded through the big opening of the figure eight descender, but not laid around the crosspiece of the figure eight descender, and instead hooked into the securing carabiner, which significantly reduces the braking performance of the arrangement, yet initially gives the impression that the rope has been laid into the belay device properly.

To counteract the problem of incorrect threading and mishandling, a number of friction-based securing devices, so-called tubes, as depicted for example in USD 466794S, have been developed, in which pulling on the belaying rope increases the braking effect of the belay device. A lot of these tubes are symmetrical, so as to provide the desired rope braking, independent of the selection of a rope end as the belaying end. Pulling on both rope ends protruding from the tube additionally allows a simple and safe verification that the rope is properly laid into the belay device. These types of tubes, however, continue to exhibit the problem that releasing the belaying rope can lead to the rope sliding through the belay device at a very high rate of speed.

Likewise known are belay devices, in which, as shown for example in DE 69 001 596 T2, the rope runs through a clamping device that is actuatable with a lever, whereby the rope can be released by the belayer via the lever position. If, however, the belayer holds the lever in the position in which he can feed rope to the climber, and the climber falls with the lever in this position, the climber can be injured when being secured with this type of device as well, even though the passage of the rope would have been blocked had the lever been released. When using the belay device of DE 69 001 596 T2, the belayer has to use his hands in an asynchronous manner to correctly control the belay device: while one hand is responsible for feeding rope or retracting rope, the other hand is responsible for operating the lever. In emergency situations, however, many belayers tend to execute at least a similar, thus synchronous, motion with their two hands. Pulling on the free end of the belaying rope is a frequent, and in the case of tubes also useful, reflex of the belayer if the climber falls into the rope, whereby pulling can also occur synchronously with both hands. If, when using the belay device of DE 69 001 596 T2 in this type of situation, the belayer pulls on the belaying rope and at the same time moves the hand on the lever downwards, which would correspond to a synchronous movement of his two hands, it can occur that due to the downward motion of the hand the lever is pulled from the blocking upper position into an intermediate position, whereby the blocking of the rope in the belay device is released. Because of this, the climber can fall an unintentionally long distance, or the weight of the climber can pull the hand of the belayer holding onto the free end of the rope into the belay device and injure it.

Centrifugal clutches for use in belay devices are known in principal from the applications WO 2010/121698 and WO 2010/1221699 A1.

The present invention has been created in view of the above described problems and has as its task the provision of a belay device that improves the safety of handling.

According to a first aspect, this task is solved by a belay device comprising a braking device and a blocking device, whereby the blocking device comprises a movable rope holding element, which is designed to be moved by a rope being held on it, whereby the blocking device is designed in a blocking state to block a movement of the rope holding element, whereby in a securing case the blocking device transitions into the blocking state, whereby a securing case exists when a movement parameter of the movement of the rope holding element of a movement parameter set lies outside a predetermined safety range of the movement parameter assigned to the respective movement parameter, characterized in that the braking device is designed to brake a movement of the rope independent of a rope movement direction.

The movement of the rope holding element is preferably coupled to the movement of the rope held therein. The rope holding element can in particular be configured in such a way that, in a securing case, the rope moves only an insignificant amount in relation to the rope holding element before the movement of the rope holding element is prevented. This preferably prevents the movement of the rope. Within the framework of the invention it is conceivable that, in the sections in which it can be in contact with the rope, the rope holding element exhibits a structure provided with protrusions (protrusion structure) to increase friction between the rope and the rope holding element.

Because the braking device is designed to brake a movement of the rope independent of a rope movement direction, a belayer can provide the necessary rope braking for lowering with the belay device, for example, independent of which end of the rope the climber has attached or tied himself into. Because the belay device provides rope braking independent of which end of the rope the climber has tied himself into, the particularly for novices frequently occurring mishandling, that the climber ties himself into an end of the rope the movement of which the belayer cannot brake, is prevented. This significantly increases the safety of the climber. If the climber falls, setting the rope in motion, the rope holding element is set in motion as well by the rope held within it. This movement is typically so sudden, that a movement parameter of the movement of the rope holding element, which is included in a movement parameter set, lies outside a predetermined safety range assigned to this movement parameter, which then blocks the movement of the rope holding element. The rope holding element is preferably configured in such a way that a rope lying therein under tension is held in place relative to the rope holding element by friction, so that a blocking of the rope holding element leads to a blocking of a movement of the rope. Consequently, next to a first safety device formed by the braking device, with which the movement of the rope can be managed in a controlled manner, the belay device comprises a second safety device that is responsible for safety in a securing case, e.g. if the climber falls. This type of two-stage safety system increases the climber's safety, and the independence of the braking effect from a movement direction of the rope reduces the risk created by selecting the wrong end of the rope. This type of belay device further allows the user to lower himself on the rope, whereby the braking device allows the lowering speed to be controlled, while the blocking device is responsible for the safety of the user in securing cases. These two functions are combined in a single belay device, whereas for a figure eight descender, for example, a second, separate safety device in the form of a Prusik knot was needed to fulfill both of these functions.

In a first modification of the belay device according to the first aspect of the invention, the movement parameter set preferably comprises a speed and/or an acceleration as movement parameters of the movement of the rope holding element. If speed is a component of the movement parameter set, the movement of the rope holding element is blocked when the speed lies outside a safety range assigned to the speed of the rope holding element, for example if it is too high, so that the movement of the rope is prevented before the person on belay reaches a speed that is too high, with which impact on a rock or the ground could result in an injury. If an acceleration of the rope holding element is a component of the movement parameter set, the movement of the rope holding element is blocked when the acceleration lies outside a predetermined safety range assigned to the acceleration, for example if the amount of acceleration is too high. If the acceleration lies outside the predetermined safety range assigned to the acceleration, it is an indication that the person on belay is falling, so that the belay device prevents the movement of the rope before the person on belay reaches a speed that would result in serious injuries in the event of impact.

A second modification of the belay device according to the first aspect of the invention is characterized in that the blocking state occurs independent of an influence being exerted by a belayer. The movement of the rope holding element is blocked regardless of whether the belayer is paying the necessary attention to the task of belaying, may be in a state of panic, has lost consciousness or is not operating the braking device in a manner to brake the rope.

In a third modification of the belay device according to the first aspect of the invention it is possible that the belay device further comprises a base element, whereby the rope holding element is configured as a rope pulley, which is mounted to be rotatable relative to the base element, and whereby the blocking device comprises a centrifugal clutch comprising a rotor, a clamping element and a coupling element, whereby the rope pulley is coupled to or configured on the rotor in such a way that a rotation of the rope pulley effects a rotation of the rotor, and whereby in the blocking state there is a coupling of the rotor to the coupling element by means of the clamping element and/or whereby in the blocking state there is a blocking of a movement of the coupling element in relation to the base element. Such a centrifugal clutch is a reliable element, with which the inventive blocking device can be realized.

Also, in a fourth modification of the belay device according to the first aspect of the invention, it is possible for the belay device that, to at least one of the movement parameters of the movement parameter set, a predetermined safety range is assigned which comprises values of the at least one movement parameter that characterize a movement of the rope holding element in a first direction, and which comprises values of the at least one movement parameter that characterize a movement of the rope holding element in a second direction, whereby the second direction is different from the first direction. If such a predetermined safety range is assigned to a movement parameter of the rope holding element, the rope holding element can move in two directions which are different from one another, without the existence of a securing case. Since the rope holding element is designed to be moved by a rope being held on it, this type of belay device allows both the use of the braking device to brake a movement of the rope independent of a rope movement direction, as well as the use of the blocking device, which permits a movement of the rope in two directions. To a particularly great extent this prevents incorrect use of the belay device by tying or attaching the climber into the wrong end of the rope.

In a fifth modification of the belay device according to the first aspect of the invention, the belay device can be characterized in that the braking device is configured separately from the blocking device. In this way, the braking device and the blocking device can be configured to their respective function independently of one another, so that a particularly good braking of the rope and a particularly reliable blocking of the rope holding element is made possible. The braking device can in particular be separately configured from the rope holding element or the rope pulley, so that the structural constraints resulting from a movability of the rope holding element do not compromise the design of the braking device being as optimal as possible.

It is likewise possible, that in a sixth modification of the belay device according to the first aspect of the invention, the blocking device is designed in a free-running state to allow the movement of the rope holding element, whereby in the free-running state the braking device is designed to brake the movement of the rope independent of the rope movement direction. In the free-running state, the belayer can lower either the climber or himself and control the speed by using the braking device, so that a safe output speed can be set without a blocking of the rope holding element.

Similarly, in a seventh modification of the belay device according to the first aspect of the invention, in a ready state of the belay device, the braking device can be disposed, substantially fixed in position, at a coupling point of the belay device, which is provided on an external belay point for the purpose of coupling. If the braking device does not move significantly in relation to a coupling point of the belay device, to which is attached, for example, the climbing harness of the belayer or a strap loop secured to a climbing hook, the likelihood that the belayer's hand or clothing would get into the braking device while belaying decreases, because the position of the braking device with respect to the coupling point does not change significantly and the belayer does not have to repeatedly check the position of the braking device while belaying.

In an eighth modification of the belay device according to the first aspect of the invention, the braking device can in particular exhibit at least one friction surface, preferably two friction surfaces, for braking the rope. A particularly simple and reliable braking device is provided in this manner. If two friction surfaces are provided, each of the friction surfaces can to a particular extent be configured in one respective direction, which advantageously increases the braking effect of the braking device.

In a preferred embodiment, in a ninth modification of the belay device according to the first aspect of the invention, the braking device is configured as an annular element. This can prevent the rope from slipping out of the braking device.

Within the framework of this application, an annular element should be understood to be elements which enclose a hollow section in such a way that a rope going through this hollow section is prevented by the annular element from simply being moved out of the hollow section in a direction transverse to the extension direction of the rope.

A simple movement out of the hollow section means that, without arranging the rope in a particular, curved manner, at any time there is the possibility of moving the rope in a direction transverse to the extension direction of the rope, for example through a gap in the annular element, out of the hollow section of the annular element to the outside. For a simple movement the gap is twice as wide, preferably 1.5 times as wide, most preferably 1.1 times as wide as the rope suited for use with the belay device. The annular element can in particular exhibit a gap or an opening that is provided with a device to close the gap in such a way that the rope, which goes through the hollow space in the interior of the annular element, cannot be moved out of the annular element in a direction transverse to the extension direction of the rope by a movement of the rope to the side. The annular element can consist of multiple sub-elements, which do not form an annular element until they are assembled, for example in a ready state of the belay device. It is conceivable that components of an annular element can be disposed in a manner in which they are movable relative to one another. Components of an annular element can in particular be designed to close gaps or openings in the annular element as a result of a movement.

In a tenth modification of the belay device according to the first aspect of the invention, the belay device can be characterized in that the braking device is designed to flip open on the belay device for threading a rope. This makes it easier to thread the rope.

According to a second aspect, this task is solved by a belay device, which can comprise the features of a belay device according to the first aspect and its modifications, comprising a braking device and a blocking device, whereby the braking device is designed to brake a movement of the rope, whereby the blocking device comprises a movable rope holding element, which is designed to be moved by a rope being held on it, whereby the blocking device is designed in a blocking state to block a movement of the rope holding element and in a free-running state to allow the movement of the rope holding element, characterized in that the blocking device is configured in such a way that a load change on one end of the rope effects a transition from the blocking state to the free-running state. If the person on belay is hanging in the rope and the rope holding element is blocked, this blocking will interfere with, preferably block, a movement of the rope. Even for heavy climbers hanging in the rope, a load change on the rope represents easy and comfortable operation of the belay device by the belayer, requiring very little effort, so that the belay device can be safely transitioned into the free-running state. It is in particular not necessary to completely release the load on the rope threaded into the belay device to effect a transition from the blocking state to the free-running state. Releasing the load would only be possible by applying a considerable amount of force. In order to ensure a high degree of safety, the idea is in particular that the blocking device is configured in such a way that, starting from a position of the rope holding element in a transition from the blocking state to the free-running state, the blocking device is designed to block the movement of the rope holding element before the rope holding element has run through a predetermined movement section.

In a first modification of the belay device according to the second aspect of the invention, the load change on a belaying end of the rope can be effected by pulling on the belaying end away from the belay device. This procedure for changing the load ensures that the belayer has secured the belaying end in the transition from the blocking state to the free-running state, so that a controlled movement of the rope is made possible.

In a second modification of the belay device according to the second aspect of the invention, it is possible that the load change on a load end of the rope is effected by pulling the load end towards the belay device. Therefore, in a panic situation, the belayer can also effect the transition from the blocking state to the free-running state by pulling on a load section of the rope, so as to reduce the amount of time a possibly injured person on belay is hanging on a blocked rope. Here too it is not necessary to completely release the load on the rope to effect a transition from the blocking state to the free-running state, which is again possible only with a considerable amount of effort.

In a third modification of the belay device according to the second aspect of the invention the belay device can in particular be characterized in that the blocking device comprises a centrifugal clutch comprising a coupling element, whereby the coupling element is disposed in the belay device in such a way that the coupling element can execute a movement inside the belay device, and that the movement of the coupling element can be blocked, whereby the load change of the rope effects a release of the blocking of the coupling element. The provision of a blockable coupling element allows the use of a known centrifugal clutch in the belay device and restricts the interplay of the load change of the rope to only the movement of the coupling element, whereby the blocking of the coupling element preferably occurs in the blocking state of the blocking device.

In a fourth modification of the belay device according to the second aspect of the invention, which also includes the features of the third modification of the belay device according to the second aspect, the centrifugal clutch can further comprise a rotor and a clamping element, whereby in the blocking state there is a coupling of the rotor to the coupling element by means of the clamping element and whereby releasing the blocking of the coupling element releases the coupling of the rotor to the coupling element. Such a configuration of the centrifugal clutch, which preferably couples if the speed lies outside a predetermined safety range assigned to the speed or the acceleration lies outside a predetermined safety range of the rope holding device assigned to the acceleration, ensures that releasing the blocking of the coupling element releases the coupling of the rotor to the coupling element, by means of which the rotor can again rotate in the centrifugal clutch and a dangerous movement of the rope holding element can be detected. By releasing the blocking, the coupling element is able to move, which preferably results in taking pressure off the clamping element, which is preferably in contact with the rotor and the coupling element when coupling the rotor to the coupling element and, once pressure is removed, releases from its contact, which releases the coupling of the rotor to the coupling element.

In a fifth modification of the belay device according to the second aspect of the invention, which also includes the features of the third or fourth modification of the belay device according to the second aspect, it is possible that the blocking device further comprises a control element, which is designed to assume a blocking position, whereby the coupling element exhibits a stop element, whereby in the blocking position in the blocking state the stop element cooperates with the control element in such a way that the movement of the coupling element in the belay device is blocked, and whereby, upon a movement of the control element out of the blocking position out of the blocking state, the stop element cooperates with the control element in such a way that the blocking of the movement of the coupling element in relation to the belay device is released. With the provision of the stop element on the coupling element and a control element, which cooperates with the stop element, preferably in the form of contact or in the form of a cam guide surface interaction, a particularly simple control concept to block the movement of the coupling element and release this blocking in the belay device is realized.

In a sixth modification of the belay device according to the second aspect of the invention, it can be characterized in that the blocking device comprises a centrifugal clutch comprising a clamping element, whereby the clamping element is disposed in the belay device in such a way that the clamping element can execute a movement inside the belay device, and that the movement of the clamping element can be blocked, whereby the load change of the rope effects a release of the blocking of the clamping element. The provision of a blockable clamping element allows the use of a known centrifugal clutch in the belay device and restricts the interplay of the load change of the rope to only the movement of the clamping element, whereby the blocking of the clamping element preferably occurs in the blocking state of the blocking device. This also makes a separate coupling element unnecessary, which reduces the number of components, and therefore the costs.

In a seventh modification of the belay device according to the second aspect of the invention, the centrifugal clutch in the belay device can further comprise a rotor, whereby in the blocking state there is a coupling of the rotor to the control element by means of the clamping element, and whereby releasing the blocking of the clamping element releases the coupling of the rotor to the control element. This simple concept allows that releasing the blocking of the clamping element simultaneously releases the coupling of the rotor to the control element, by means of which the procedure of releasing the coupling of the rotor to the control element can proceed in a less complicated manner and is thus less prone to malfunction.

Also possible, in an eighth modification of the belay device according to the second aspect of the invention, is that the belay device is characterized in that control element is designed to assume a blocking position, whereby the clamping element exhibits a stop element, whereby in the blocking position in the blocking state the stop element cooperates with the control element in such a way that the movement of the clamping element in the belay device is blocked, and whereby, upon a movement of the control element out of the blocking position out of the blocking state, the stop element cooperates with the control element in such a way that the blocking of the clamping element within the belay device is released. With the provision of the stop element on the clamping element and a control element, which cooperates with the stop element, preferably in the form of contact or in the form of a cam guide surface interaction, a particularly simple control concept to block the movement of the clamping element and release this blocking in the belay device is realized.

In a ninth modification of the belay device according to the second aspect of the invention, which also includes the features of the fifth modification of the belay device according to the second aspect, it is conceivable to mount the braking device to the control element. The braking device can in particular be formed as one piece with the control element or the braking device can be mounted to the control means via a joint, for example a hinge. If the braking device is mounted to the control means, the control element is moved via an actuation of the braking device, which releases the blocking of the coupling element. However, while releasing, a braking effect can already be acting on the rope, so that a movement of the rope can be braked.

It is in particular possible to modify a belay device according to the second aspect of the present invention in all its modifications with the features of modifications five to ten of the belay device according to the first aspect of the present invention, without incorporating other features of the belay device according to the first aspect of the present invention.

According to a third aspect of the present invention, the present task is solved with a belay device, which can exhibit the features of a belay device according to the first or second aspect, including all modifications, comprising a blocking device, whereby the blocking device comprises a movable rope holding element, which is designed to be moved by a rope being held on it, whereby the blocking device is designed in a blocking state to block a movement of the rope holding element and in a free-running state to allow the movement of the rope holding element, whereby in a securing case the blocking device transitions from the free-running state to the blocking state, whereby the blocking device further exhibits a control element, the actuation of which in the blocking state effects the transition of the blocking device into the free-running state, characterized in that, as soon as the securing case exists, the blocking device assumes the blocking state independent of an actuation of the control element, in particular by a belayer, before the rope holding element has run through a predetermined movement section. If a securing case is detected, for example by a centrifugal clutch, the blocking device assumes the blocking state before the rope holding element has run through a predetermined movement section. This occurs even if the belayer effects the transition from the blocking state to the free-running state by means of the control element, which can prevent the person on belay from gaining too much speed. If, for example, the climber is hanging in the rope, and the belayer effects a transition of the blocking device from the blocking state to the free-running state without ensuring that the belaying rope is adequately braked, i.e. the securing case essentially occurs immediately after the transition to the free-running state, the rope holding element is moved by the rope and, after the rope holding element has run through a predetermined movement section, the blocking device transitions to the blocking state due to the existence of the securing case. This transition occurs regardless of whether the control element has been or is being actuated. In particular, this prevents the blocking device from assuming an inactive state while the control element is being actuated, in which the blocking device cannot block a movement of the rope holding element and that is not canceled until the control element is actuated again. Thus, in the event of a securing case, the movement of the rope in the belay device is advantageously limited; preferably limited to a rope run length of less than 1 m, particularly preferred less than 0.5 m, highly preferred less than 0.2 m. A fall of the climber, resulting from incorrect operation when releasing a blocking of the rope, is thus safely prevented.

It is in particular possible to provide a braking device in a belay device according to the third aspect of the present invention in all its modifications, and to modify such a belay device with the features of modifications five to ten of the belay device according to the first aspect of the present invention, without incorporating other features of the belay device according to the first aspect of the present invention.

According to a fourth aspect of the present invention, the present task is solved with a belay device, which can exhibit the features of a belay device of the first, second or third aspect in all modifications, comprising a braking device and a blocking device, whereby the blocking device comprises a centrifugal clutch and whereby the braking device is separately configured of movable parts of the centrifugal clutch. A belay device, in which the blocking device comprises a centrifugal clutch and a braking device that is separately configured of movable parts of the centrifugal clutch, constitutes a simple and safe embodiment of a belay device.

In a first modification of the belay device of the fourth aspect, the braking device is configured as an annular element. Such a configuration of the braking device prevents the rope from slipping out of the braking device.

In a second modification of the belay device of the fourth aspect, the blocking device can comprise a movable rope holding element, which is designed to be moved by the rope being held on it, whereby the rope holding element is coupled with the centrifugal clutch, whereby the centrifugal clutch comprises a first and second section of the centrifugal clutch, whereby the centrifugal clutch is designed in a blocking state to block a movement of the rope holding element and to brake a movement of the rope, whereby in a securing case the centrifugal clutch transitions into the blocking state, whereby the securing case exists when a movement parameter of the movement of the rope holding element of a movement parameter set lies outside a predetermined safety range of the movement parameter assigned to the respective movement parameter, whereby the first section of the centrifugal clutch is designed in the event of a securing case to block a movement of the rope holding element when the rope holding element moves in a first direction, and is designed to allow the movement of the rope holding element when the rope holding element moves in a second direction, which is opposite to the first direction, whereby the second section of the centrifugal clutch is designed in the event of a securing case to block the movement of the rope holding element when the rope holding element moves in the second direction, and is designed to allow the movement of the rope holding element when the rope holding element moves in the first direction. Providing the first and second sections of the centrifugal clutch with separate tasks allows the individual sections of the centrifugal clutch to be adapted particularly well to the respective task. In addition, for example in the event of an accident caused by a malfunction of one of the sections of the centrifugal clutch, the belay device can be used for belaying, whereby the load end and the belaying end of the rope are to be selected in accordance with the undamaged section of the centrifugal clutch. A redundancy is hereby provided, which allows the continued use of the belay device in the event of malfunctions.

In aspects one to four of the resent invention, the blocking device can comprise a catch mechanism. The catch mechanism is preferably designed to allow at least an incremental movement of the rope holding element. In aspects one to four of the resent invention, the blocking device can, if not already described, comprise a centrifugal clutch, preferably with an, in particular movable, coupling element and/or an, in particular movable, control element and/or a rotor and/or a clamping element.

The coupling element can exhibit the function of a ratchet wheel of the catch mechanism. The control element can further exhibit the function of a catch in the catch mechanism. The catch mechanism is preferably designed to incrementally allow a movement of the coupling element. In a particularly preferred embodiment, the catch mechanism is designed to limit the movement of the coupling element to movement sections. The catch mechanism is preferably configured to be symmetrical with reference to the possible movement directions of the rope holding element. The rope holding element can be configured as a rope pulley. Advantageously, the rope pulley is rotatably mounted, which allows the playing out and/or the retraction of the rope on the belay device to be particularly comfortable. The rope pulley can be rotatably mounted in a low-friction manner, whereby the mounting of the rope pulley is preferentially realized by means of a slide bearing. The use of a slide bearing allows a cost-effective, low-friction, rotatable mounting of the rope pulley. The realization of the rotatable mounting of the rope pulley with the aid of a ball bearing should not be excluded either. The catch mechanism is preferably configured to be symmetrical with reference to the forward and backward rotation of the rope pulley. It is likewise possible that the catch mechanism is designed to limit the movement of the rope holding element to movement sections, preferably in cooperation with the coupling element, particularly preferably in cooperation with the centrifugal clutch, most preferably in the presence of a coupling of the rotor to the coupling element. The idea is in particular that a predetermined structure of the coupling of the rotor to the coupling element is created by snapping the clamping element into the coupling element.

It is possible to divide the centrifugal clutch and/or the catch mechanism into two sections, whereby the first section of the centrifugal clutch and/or the catch mechanism is designed in the event of a securing case to effect a transition of the blocking device to the blocking state when the rope holding element moves in a first direction, and in the event of a securing case to not effect a transition of the blocking device to the blocking state when the rope holding element moves in a second direction different, preferably opposite, to the first direction and whereby the second section of the centrifugal clutch and/or the catch mechanism is designed in the event of a securing case to effect a transition of the blocking device to the blocking state when the rope holding element moves in the second direction, and in the event of a securing case to not effect a transition of the blocking device to the blocking state when the rope holding element moves in the first direction.

In all aspects and modifications of the present invention the belay device can further comprise a base element and a coupling point, which is provided on an external belay point for the purpose of coupling, whereby the blocking device comprises a movable rope holding element, which is designed to be moved by a rope being held on it, the rope holding element is configured as a rope pulley, which is mounted to be rotatable relative to the base element, the coupling point is configured to be stationary in relation to the base element, and the rotational axis of the rope pulley is configured to be stationary in relation to the base element. In such a configuration, the belay device is configured in a particularly simple manner, a coupling point, in particular an opening to thread in a carabiner, is fixedly configured on the base element and, on the same base element, a rotational axis of the rope pulley is configured fixed in position with reference to the base element; for example by means of a rotary shaft fixed in position with reference to the base element. This creates a transmission of force from the rope pulley to the coupling point via a particularly small number of elements. This not only promotes a simple and cost-effective construction, but rather, in particular if the rotary shaft of the rope pulley is attached to the base element in a stationary and preferably torque-proof manner, this type of construction increases the reliability of the belay device, because the force is transmitted from the rope pulley to the coupling point via a particularly small number of elements. Since a housing of the belay device can be configured as a base element of the belay device, in particular for multipart housings, in which multiple sections, which are displaceable and/or rotatable in relation to one another, exhibit coupling points or coupling point sections, the above described embodiment of the present invention is to be understood to mean that the rotational axis of the rope pulley is configured fixed in position with reference to a section of the housing, and that the coupling point is configured fixed in position with reference to this section of the housing. A section of the housing (housing section) can in particular be configured as a base element. A coupling point configured fixed in position with reference to a housing section also includes through-openings or coupling points for threading a carabiner, which are configured fixed in position with reference to this housing section and which in the ready state of the securing device can only be used in conjunction with another through-opening or another coupling point. This would in particular be a two-part housing, whereby an opening is provided in the one part as well as in the other part of the housing, and in a ready state of the belay device the two openings are lined up, so that a carabiner can be passed through.

In all aspects and modifications of the present invention, the belay device can be configured in such a way that the braking device is configured as an annular element, which is designed to be flipped open, whereby the annular element preferably exhibits a first sub-element and a second sub-element and, if the annular exhibits a first sub-element and a second sub-element, in a particularly preferred embodiment, the annular element is designed to be flipped open by displacing and/or rotating the first sub-element and the second sub-element relative to one another. This increases the operating comfort of the belay device, because laying the rope into the belay device by means of the flipped open annular element is particularly convenient.

The belay device is not only suited for use when climbing. It can also be used to lower a climber, to lower the belayer himself or for belaying when solo climbing. The belay device is also not limited to use in the field of climbing; it can be used whenever a load or a person has to be secured on a rope, e.g. industrial climbing, mountain rescue, as well as police and fire department operations. Therefore, within the framework of this application, terms such as the climber or the person on belay are used synonymously.

Embodiments of the invention are described in the following with reference to the attached drawings. The drawings show:

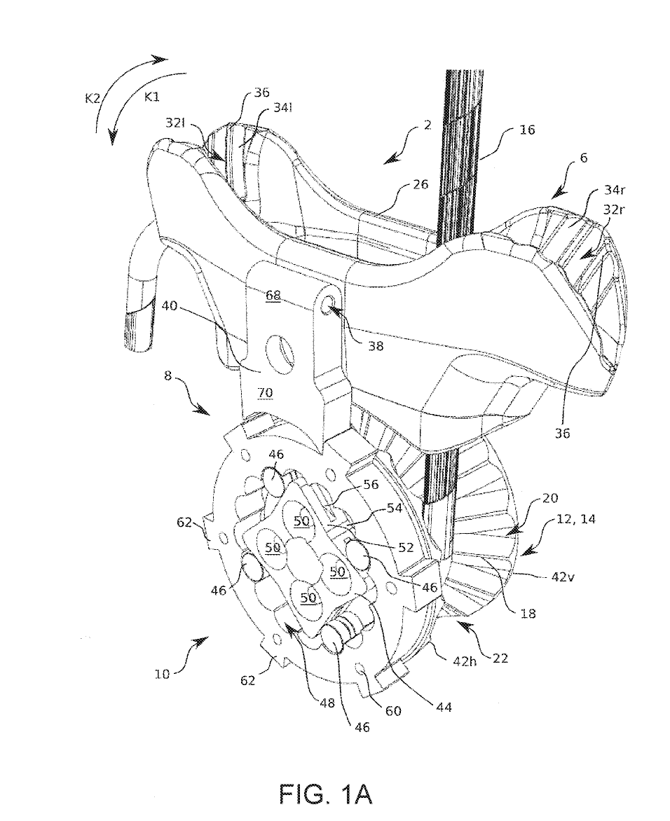

FIG. 1a a first view of the first embodiment of the present invention;

FIG. 1b a second view of the first embodiment of the present invention, in which elements of an alternative are shown as well;

FIG. 1c a stop element

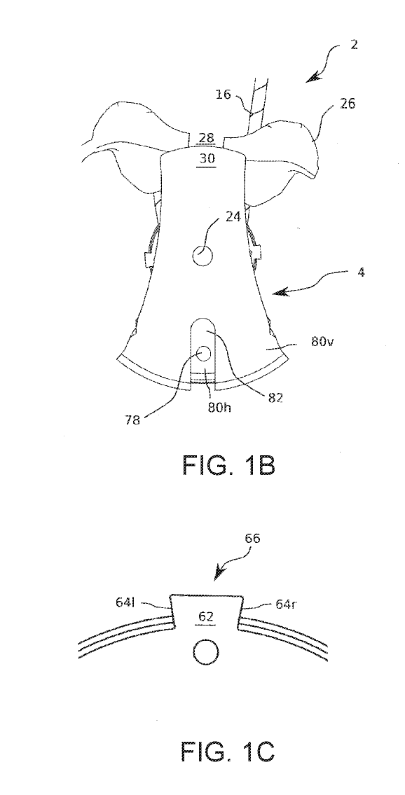

FIG. 2 a use of the first embodiment of the present invention;

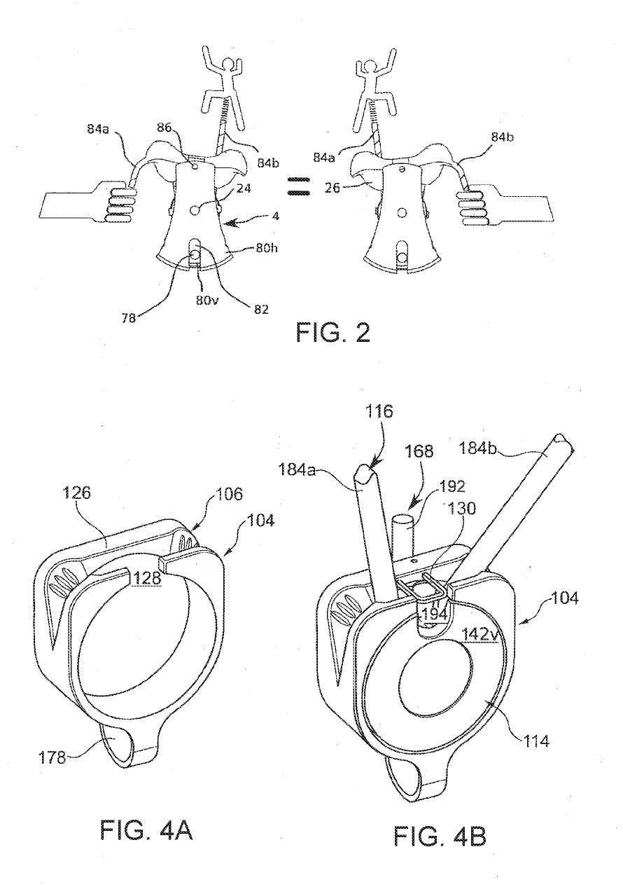

FIGS. 3a-3f the function of the first embodiment of the present invention;

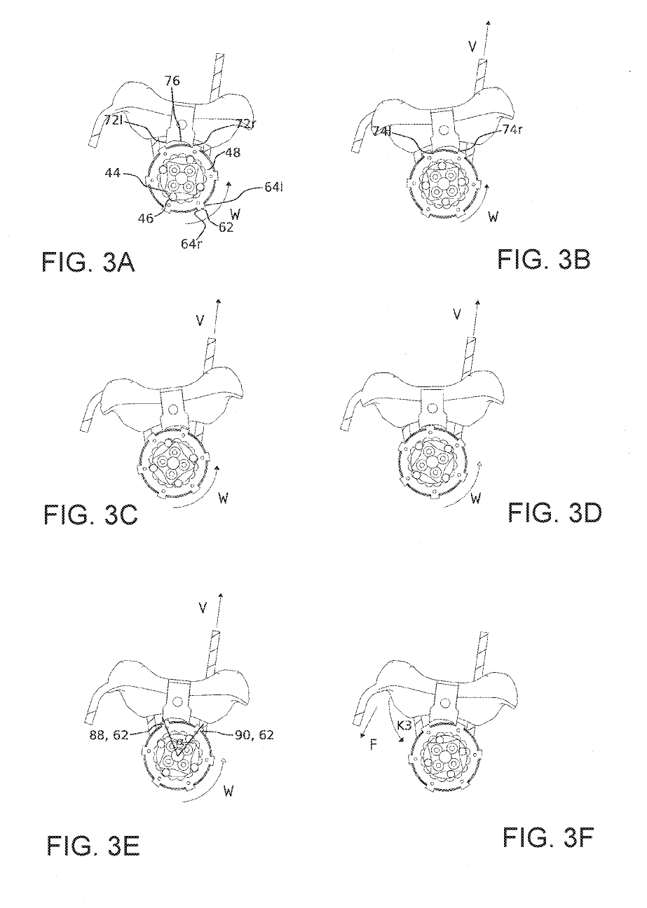

FIG. 4a a simplified representation of the housing of a second embodiment of the present invention; and

FIG. 4b a view of the second embodiment of the present invention;

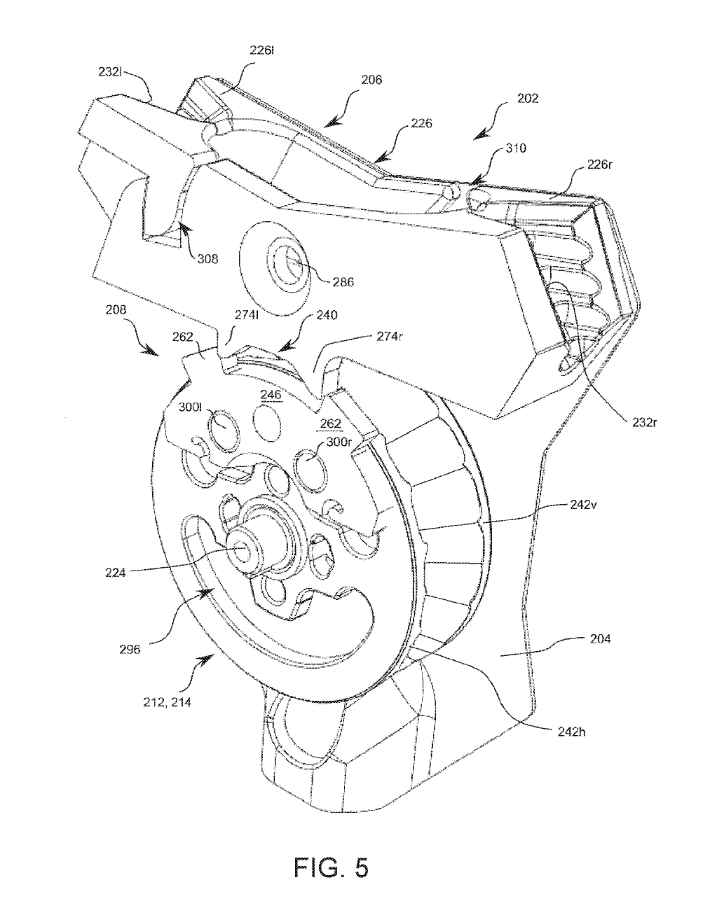

FIG. 5 a first view of the third embodiment of the present invention;

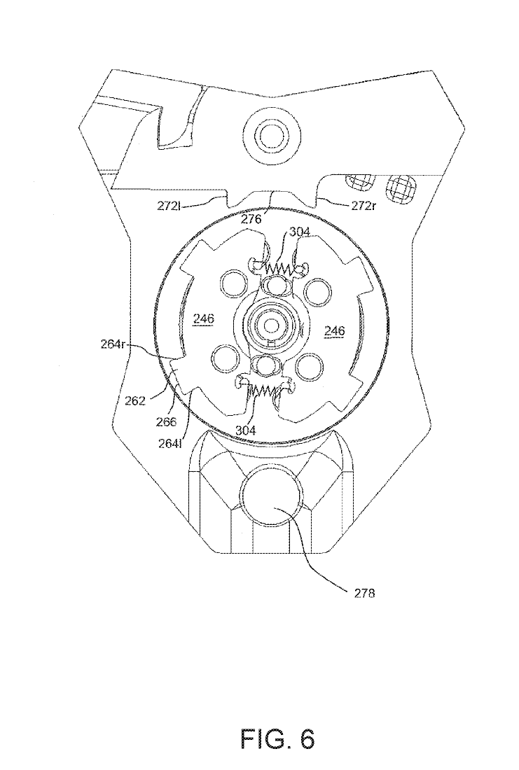

FIG. 6 a second view of the third embodiment of the present invention;

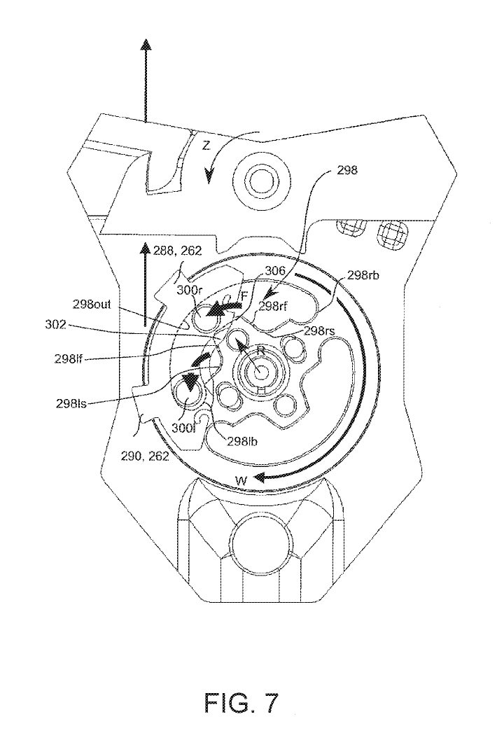

FIG. 7 a third view of the third embodiment of the present invention;

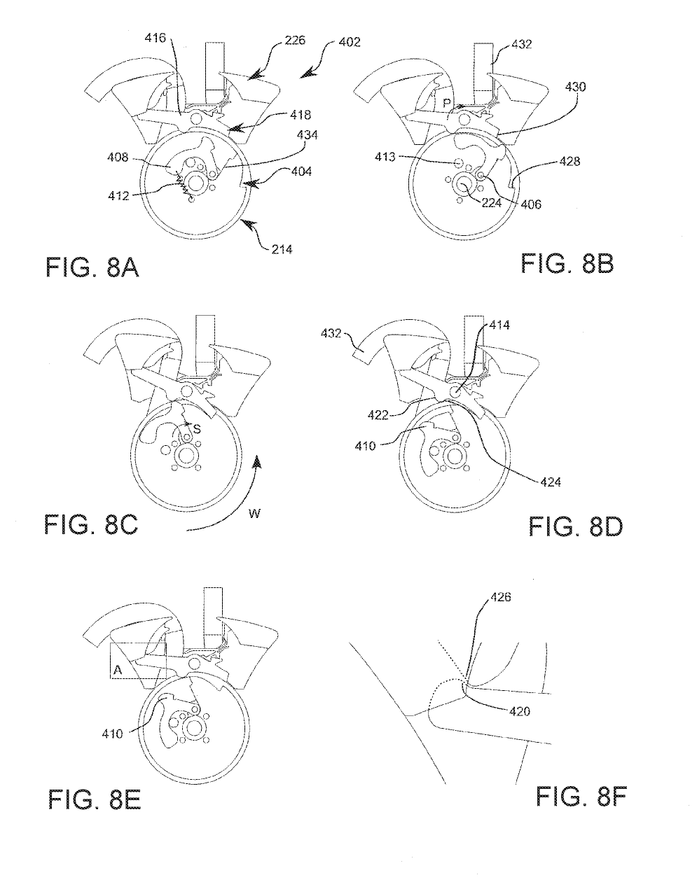

FIGS. 8a-8e views of a fourth embodiment of the present invention, in which the area A is marked in FIG. 8e by means of a rectangle;

FIG. 8f an enlarged representation of the area A from FIG. 8e, in which several covered contours are indicated by means of dashed lines;

whereby views also includes partial views, sectional views etc.

### FIRST EMBODIMENT

FIG. 1a shows a first embodiment of a belay device 2 according to the invention, whereby a housing 4 (see FIG. 2) in has been omitted FIG. 1a. The belay device comprises a braking device 6 and a blocking device 8. The blocking device 8 preferably comprises a centrifugal clutch 10. It is also possible that the blocking device comprises a movable rope holding element 12, which in a preferred embodiment is configured as a rope pulley 14. The rope holding element 12 can be moved by the rope 16, if the rope 16 is held by the rope holding element 12. The movement of the rope is transmitted to the rope holding element 12, for example by friction of the rope 16 on a support surface 20 provided with a protrusion structure 18. In a particularly preferred embodiment, the support surface 20 is provided on the inside of a rope holding groove 22 of the rope pulley 14. The protrusion structure 18 is preferably provided in the rope holding groove 22, and can taper toward the center of the rope holding groove 22. This allows ropes 16 with a variety of diameters to be used in the belay device 2, because under load the rope 16 can wedge itself into a suitable tapered section of the protrusion structure 18 appropriate to its diameter. The rope holding element 12 is preferably configured in such a way that, substantially without slipping, the rope 16 effects a movement of the rope holding element and, in particular advantageous embodiment, a blocked rope holding element can prevent the slipping of the rope 16 on the rope holding element 12 with friction, and thus prevent a movement of the rope 16. If, as shown in FIG. 1a, the protrusion structure 18 is configured on the side walls of the rope holding groove 22, the rope 16 seizes in the converging walls of the rope holding groove 22 and a slipping of the rope 16 when the rope 16 is loaded is prevented.

### Braking Device

The braking device 6 is preferably configured separately from the blocking device 8, in particular separate from movable parts of the blocking device 8. If the blocking device comprises a centrifugal clutch 10, the braking device is in particular configured separately from the movable parts of the centrifugal clutch 10. The braking device 6 can partially, in particular completely, be made of metal, so as to be able to dissipate the heat generated by braking the rope 16. If the braking device 6 is partially or completely made of metal, it exhibits a high resistance to attrition and is thus configured to be particularly wear-resistant.

The housing 4 of the belay device 2 can exhibit a seat or a bearing of a first rotary shaft 24, whereby the first rotary shaft 24 can be designed to accommodate the rope holding element.

In the design example shown in FIG. 1a, the braking device is configured as an annular element 26, which completely encloses an opening (an interior space of the annular element 26), through which a rope loop of the rope 16 can be threaded, and the rope 16 can be accommodated on the rope holding element 12.

It is also possible, however, as shown in FIG. 1b to modify the first embodiment to the extent that the annular element 26 is provided with a gap 28 (to provide a better overview, the rear wall of the annular element 26 behind the gap 28 is not depicted in FIG. 1b), so that the rope 16 can enter the interior space of the annular element 26 through the gap, so as to facilitate the holding of the rope on the rope holding element 12. It is also possible to provide a closure element 30, which can preferably be locked and unlocked, by means of which laying the rope 16 into the interior space of the annular element 26 can be facilitated, and also, when the closure element 30 is locked, the rope 16 can be prevented from sliding out through the gap 28.

The braking device 6 exhibits at least one friction surface 32r, 32l, preferably two friction surfaces 32r and 32l. The at least one friction surface 32r, 32l can partially, in particular completely, be made of metal, so as to be able to dissipate the heat generated by braking the rope 16. The friction surfaces 32r, 32l are able to brake the rope 16 independent of the movement direction. Modifying the position of the rope section at which the belayer is controlling the movement of the rope with respect to the belay device 2, as is done with a tube, is usually enough to make this happen. Such a friction surface is in particular configured to be concave, so that the rope 16 is deformed in the concave friction surface 32r, 32l and a braking of the rope 16 by friction occurs to a greater extent also on the side walls 34r, 34l of the concave friction surface 32r, 32l. The side walls 34r, 34l and/or the base section lying between the side walls 34r or 34l can be provided with ribs 36, or otherwise configured protrusions (not depicted), to increase the friction of the rope 16 in the braking device 6, and thus support the braking of the rope 16.

As shown in FIG. 1a in the first design example, the braking device 6 is preferably disposed on the belay device in a manner in which it can be flipped open. The flipping open is realized by a hinge 38, partially indicated in FIG. 1a, which connects the annular element 26 to a control element 40. If the annular element 26 is flipped open at the hinge 38 in direction K1, a rope loop of the rope 16 can be pushed through the opening of the annular element to be laid around the rope pulley 14. The annular element 26 can be flipped closed in direction K2. The opening of the annular element 26 preferably tapers substantially with the rope holding groove 22.

### Blocking Device

The blocking device 8 comprises the rope holding element 12 configured in the first embodiment as a rope pulley 14 and in a blocking state to be described later blocks a movement of the rope holding element 12, here the rotation of the rope pulley 14. The movement of the rope 16 is coupled to the movement of the rope pulley 14 by means of the support surface 20. In a preferred embodiment, as shown in the first embodiment, the rope pulley 14 can comprise a first half pulley 42v and a second half pulley 42h, which are preferably disposed fixed in position relative to one another; the rope pulley 14 can, however, also be configured in one piece. The blocking device 8 further preferably comprises the centrifugal clutch 10. The centrifugal clutch preferably comprises at least one rotor 44, at least one clamping element 46 and at least one coupling element 48. The rotor is preferably connected to the rope pulley 14 in a torque-proof manner, for example by connecting the rotor 44 and the rope pulley 14 to the first rotary shaft 24 in a fixed manner, or connecting them to one another in a fixed manner, but connecting them to the rotary shaft 24 in a rotatable manner. It also conceivable, however, to mount the rotor 44 to a first rotating section of a not depicted friction clutch in a torque-proof manner and to mount the rope pulley 14 to a second rotating section of the not depicted friction clutch in a torque-proof manner, so that, when the rotation of the rotor 44 is blocked, the not depicted friction clutch cushions a stop operation, by means of which a fall of the person on belay is cushioned.

To reduce weight, the rotor 44 preferably exhibits at least one recess 50. The rotor 44 further exhibits at least one contact surface 52 to interact with the at least one clamping element 46. The contact surface 52 preferably exhibits a notch 54, which defines a neutral position of the at least one clamping element 46. It is possible for the contact surface 52 to exhibit a guide groove 56, in which an elastic element (not depicted) to restrain the at least one clamping element 46 is guided. In a preferred embodiment, the elastic element is an elastic strap, whereby a guiding of the at least one clamping element 46 on the elastic strap is ensured by an additional guide groove in the at least one clamping element 46. In a particularly preferred embodiment, an elastic element can alternatively be configured as a spring assembly to restrain the at least one clamping element 46, which preferably couples to both the at least one clamping element 46 and the rotor 44. If multiple, preferably two, clamping elements 46 are provided, there is the further alternative possibility to configure an elastic element as a spring assembly for restraining at least two clamping elements 46, which preferably couples the two clamping elements 46 to one another. The at least one clamping element 46 is preferably pretensioned by the spring assembly or the elastic element in the direction towards the rotor 44. To ensure the certainty of the function of the centrifugal clutch 10, the centrifugal clutch preferably comprises a plurality of contact surfaces 52 and preferably a plurality of clamping elements 46. The at least one clamping element 46 preferably exhibits a cylindrical shape.

The coupling element 48 is preferably movably disposed in the housing 4. The coupling element 48 preferably has an annular design. In a preferred embodiment, the coupling element 48 exhibits an inner surface, to which the at least one clamping element 46 can couple in interplay with the rotor 44, so that the rotor 44 is not rotatable relative to the coupling element 48 at least in one rotation direction of the rotor 44, i.e. is coupled with the coupling element 48. The coupling of the at least one clamping element 46 can in particular be achieved by the inner surface of the coupling element 48 exhibiting a structure adapted to the shape of the at least one clamping element 46, into which the at least one clamping element 46 can engage. Imagined is here in particular a toothed arrangement. In a particularly preferred embodiment, the inner surface of the coupling element 48 exhibits a toothed arrangement, in which the spaces between the teeth are configured as sections of a round, preferably cylindrical, aperture wall. The coupling element 48 is preferably rotatable relative to the rope pulley 40, in particular rotatably mounted on the first rotary shaft 24.

For weight reduction, the coupling element 48 is in turn preferably provided with at least one cutout 60. In a particularly preferred embodiment, the coupling element 48 is provided with at least one stop element 62 on its outside circumference, preferably with a plurality of stop elements 62, which are preferably configured as a protrusion. The stop element 62 preferably exhibits a first contact surface 64r and a second contact surface 64l, see FIG. 1c. In a particularly preferred embodiment, the stop element 62 exhibits a cam section 66. In a preferred embodiment, as will be described later, the stop element 62 cooperates with the control element 40. The control element 40 is preferably rotatably disposed on the housing 4. It in particular exhibits a first section 68, with which a belayer can engage directly and indirectly to make it move, and a second section 70, which is designed to cooperate with the stop element 62. In a particularly preferred embodiment, the second section exhibits a left stop surface 721 and a right stop surface 72r, a left 74l and a right 74r limiting tab, as well as an interjacent cam guide surface 76.

If there is no coupling of the rotor 44 to the coupling element 48 by means of the at least one clamping element 46, the rope holding element 12, configured for example as a rope pulley 14, can move in a free-running state. The direction-independent braking effect of the braking device 6 on the rope 16 is independent of the existence of the free-running state; it is achieved, for example, by the rope pulley 14 being configured separately from the braking device 6.

### Housing

The housing 4 or a part of the housing 4 can be configured as a base element, relative to which the rope pulley 14 can rotate.

To couple the belay device to an external belay point, for example a climbing harness or a strap loop, the belay device 2, preferably the housing 4, exhibits a coupling point, preferably in the form of an opening 78. The housing 4 preferably exhibits a first half 80h and a second half 80v, whereby in particular the control element 40 is rotatably mounted to the first half 80h of the housing 4 and the opening 78 is preferably also configured in the first half 80h of the housing 4. The first rotary shaft 24 is preferably configured fixed in position, in particular also in a torque-proof manner, relative to the first half 80h of the housing 4. For example, the rotary shaft 24 is connected with the first half 80h of the housing 4 in such a way that the rotational axis of the rope pulley 14 defined by the rotary shaft 24 cannot move in relation to the first half 80h of the housing 4. In particular, the first half 80h of the housing 4 can by itself also be regarded as a base element. The second half of the housing 80v is preferably rotatably mounted on the first rotary shaft 24 in such a way that it can be pivoted with reference to the annular element 26 and the opening 78. The closure element 30 can in particular be integrally configured with the second half 80v of the housing 4. The second 80v of the housing 4 can further exhibit a cutout 82 that, depending on the position of the second half 80v of the housing 4 relative to the first half 80h of the housing 4, can uncover the opening 78.

As shown in FIG. 2, it is also possible, with reference to FIG. 1b, to turn the arrangement of the opening 78 and the cutout 82 around relative to the first half 80h and the second half 80v.

When belaying with the belay device, the braking device 6 configured as an annular element 26 is substantially fixed in position relative to the opening 78. The rocking motion of the braking device 6, occurring upon rotation of the control element 40 about the second rotational axis 86, is minimal, and hardly affects the arrangement of the braking device 6 relative to the opening 78.

The cutout 82 can be designed to lay the rope 16 into the rope pulley 14.

The function and the use of the belay device are described in the following.

### Preparing the Belay Device for Operation

In the first embodiment, a rope loop is laid into the belay device 2 by flipping open the annular element 26 at the hinge 38 in direction K1, laying the rope loop around the rope pulley 14 and then flipping the annular element 26 closed again at the hinge 38 in direction K2 into the position shown in FIG. 1a. It is also conceivable to configure one of the half pulleys 42v, 42h to be smaller than the other half pulley 42h, 42v, so as to facilitate laying in the rope loop of the rope.

In a not depicted preferred embodiment, the cutout 82 is disposed in the second half 80v of the housing 4 in such a way that, when the opening 78 is uncovered by the cutout 82, the gap 28 is covered by the closure element 30 integrally configured on the second half 82v of the housing 4. A carabiner, a strap loop or a rope can thus only be pushed into the opening 78 to couple to an external belay point when the gap 28 is covered by the closure element 30, so that, as soon as it is laid around the rope pulley 14, the rope 16 can no longer slip unintentionally sideways out of the belay device 2. This is in particular prevented by the fact that the first rotary shaft 24 together with the annular element 26 and the two halves 80v and 80h of the housing 4 form a substantially continuous structure, so that, even when it comes out of the rope holding groove 22, the rope loop of the rope 16 is prevented from entering the interior space of the annular element 26 by this structure, which prevents the rope loop from slipping out of the belay device 2.

### Belaying and Blocking Function

As can be seen in FIG. 2, the belay device 2 is symmetrical with respect to the use of the two rope ends 84a, 84b as a load end and a belaying end. A load end is to be understood as a section of the rope between the belay device 2 and the climber. When solo climbing or when lowering oneself, the load end is the rope section that can be loaded by the weight of the solo climber or the person lowering himself. The belaying end is the rope section separated from the load end by the belay device, by means of which the belayer preferably controls the use of the braking device. The symmetry prevents an incorrect operation of the belay device 2 by, for example, tying the climber into the wrong end of the rope.

If the person on belay is climbing, the belayer can play out the rope 16 by pulling on the load end of the rope 16 in the direction away from the belay device 2, without pressing the belaying end of the rope 16 against one of the friction surfaces 32l, 32r. Due to the friction of the rope 16 on the protrusion structure 18, the rope pulley 14 then rotates along with the rotor 44 within the housing 4. Since the speed of the rotor 44 is minimal, the centrifugal force resulting from the rotation is not large enough to release the at least one clamping element 46 from its contact with the notch 54 against the restoring force of the elastic strap. Similarly, with normal rope movement when playing out rope, the acceleration of the rope pulley 14, and thus of the rotor 44, is not large enough for the force resulting from the inertia of the at least one clamping element 46 to allow the at least one clamping element 46 to release from the notch 54 against the restoring force of the elastic strap. At a higher speed or a higher acceleration the at least one clamping element 46 can release from the notch 54, but a small deviation will also not be enough for the at least one clamping element 46 to engage with an inner toothed arrangement of the coupling element 48. The centrifugal force is not large enough for there to be a sufficient distance of the least one clamping element 46 from the notch 54, and for the at least one clamping element 46 to engage with an inner toothed arrangement of the coupling element 48, until the speed of the rotation of the rotor 44 has reached a predetermined value. The preferably slightly V-shaped contact surface 52, in which the notch 54 forms the point of the V, then wedges the at least one clamping element 46 into the inner toothed arrangement of the coupling element 48, so that a force acting on the rope pulley 14 is transmitted via the rotor 44, which is disposed in a torque-proof manner or in an at least largely torque-proof manner in relation to the rope pulley 14, via the at least one clamping element 46 to the coupling element 48. A similar situation occurs when, due to an increased acceleration, the inertial force of the at least one clamping element 46 is enough to effect a spacing of the at least one clamping element 46 from the notch 54, so that the at least one clamping element 46 engages with the inner toothed arrangement of the coupling element 48. Here too, the absolute value of the acceleration is significant.

The limit speed or the limit acceleration, beyond which there is a coupling of the rotor 44 to the coupling element 48 via the at least one clamping element 46, can be set by an appropriate selection of the elastic properties of the used elastic element, in particular the elastic strap or the spring assembly, or the distance of the notch 54 from the inner toothed arrangement of the coupling element 48.

The limit speed and/or the limit acceleration are in particular absolute values, so that, for example, all speeds in forward and backward direction with a value smaller than the limit speed belong to a safety range for the speed. Likewise, all accelerations in forward and backward direction with a value smaller than the limit acceleration belong to a safety range for the acceleration.

If a coupling of the rotor 44 to the coupling element 48 is desired only upon exceedance of the predetermined speed and not upon exceedance of a predetermined acceleration, this can be achieved by restricting the movement of the at least one clamping element 46, for example by means of a guide groove, to a movement with essentially only one radial component.

The centrifugal clutch thus detects if a movement parameter, for example the speed or the acceleration, lies outside a predetermined parameter range, in which case it couples the rotor 44, and with it also the rope pulley 14, to the coupling element 48. This coupling can effect a transition into the blocking state, preferably from the free-running state in which the rope holding element 12 can move freely.

Therefore, a securing case occurs when one movement parameter of the movement of the rope holding element 12, here the rope pulley 14, lies outside a predetermined safety range assigned to the movement parameter. Such a securing case is detected by the centrifugal clutch and is not limited to the detection of a movement parameter, but rather a securing case is in particular detected when the speed and/or the velocity of the rope pulley 14 lies outside the respective assigned predetermined safety range of the respective movement parameters.

It is also conceivable to measure movement parameters of the movement of the rope holding element by means of electronic components. In particular the rotation speed of the rope pulley and the acceleration of the rotation movement of the rope pulley can be measured by means of electronic components. Such electronic components are preferably coupled with an electronic processing device, so that, when a movement parameter of the movement of the rope pulley of a movement parameter set lies outside a predetermined safety range of the movement parameter assigned to the respective movement parameter, the electronic processing device of a correspondingly configured blocking device blocks the movement of the rope pulley. This can, for example, be implemented by means of an electrically actuatable brake of the rope pulley.

In FIG. 3a, the blocking state on the rope pulley 14 is depicted with a force acting in direction W, whereby a rotational movement in direction W of the rope pulley 14 blocked. This preferably occurs via a force transmission from the rope pulley 14 to the centrifugal clutch 10, on to the control element 40 and still further to the housing 4. A blocked rope holding element 12 preferably prevents a movement of a rope 16 being held on it. In the blocking state there is a coupling of the rotor 44 to the coupling element 48 by means of the at least one clamping element 46.

If the control element 40 and the coupling element 48 are in the position shown in FIG. 3a, and if the rotor 44 couples to the coupling element 48 via the at least one clamping element 46 in the manner shown in FIG. 3a, and if also a force, which would move the coupling element 48 in direction W, acts on the rope pulley 14, then the blocking device in FIG. 3a is in the blocking state: the control element 40, which is rotatably mounted on a second rotary shaft 86 on the housing 4, is in contact with the right limiting tab 74r on the outside circumference of the coupling element 48. There is also contact between the right stop surface 72r and the left contact surface 64l of a stop element 62. The force acting on the rope pulley 14 through the rope is hereby transmitted to the rotor 44. The rotor 44 transmits this force on to the coupling element 48 via the at least one clamping element 46. This in turn transmits this force to the control element 40 via the contact between the contact surface 64l with the stop surface 72r. In this state the movement of the coupling element 48, in particular in relation to the base element 4, is blocked. In the present design example, however, it should only be referred to as a blocking of the movement of the coupling element 48, if the contact between the contact surface 64l with the stop surface 72r is effected by a force acting on the rope pulley 14.

Since the movement of the control element 40 is limited to a rotation around the second rotary axis 86 and prevented by the contact of the limiting tab 74r on the outside circumference of the coupling element 48, this force is transmitted to the second rotary shaft 86 and ultimately to the housing 4. A movement of the rope pulley 14 is thus blocked. In this way, as a result of the configuration of the rope pulley 14, the movement of the rope 16 is preferably blocked as well.

On the other hand, if there is a situation as is shown in FIG. 3b, the coupling element 48 can still rotate in direction W, because there is no contact between a stop surface 72r and a contact surface 64l. In this case, if the same force relationships are present as have been discussed in reference to FIG. 3a the cam section 66 of the stop element 62 slides along the cam guide surface 76 of the control element 40. The movement of the control element 40, resulting from the movement of the coupling element 48 in the interplay of the cam section 66 and cam guide surface 76, is shown in FIGS. 3c to 3e. As soon as the coupling element 48 has at most completed a first predetermined movement section, the movement of the cam section 66 along the cam guide surface effects a convergence of the right limiting tab 74r to the outside circumference of the coupling element 48. If one stop element 62 is provided, the length of the first predetermined movement section is limited by 360°; if there are multiple stop elements 62, the length of the first predetermined movement section is determined by the angular arrangement of the stop elements 62. Due to the existing coupling of the rotor 44 to the coupling element 48, the coupling element 48 is coupled to the movement of the rope pulley 14 so that, as soon as the rope pulley 12 has at most completed the first predetermined movement section, the movement of the cam section 66 along the cam guide surface 76 effects a convergence of the right limiting tab 74r to the outside circumference of the coupling element.

As soon as the right limiting tab 74r has come into proximity with the outside circumference of the coupling element 48, an interaction of the cam section 66 of a first stop element 88 with the left limiting tab 74l prevents a counterclockwise rotation of the control element 40 about the second rotary shaft 86 until the position of a second stop element 90 has changed enough that a counterclockwise rotation of the control element 40 would effect a contact of the stop surface 72r or the limiting tab 74r with the contact surface 64l of the second stop element 90. The control element 40 is then in a blocked position.

If the coupling element 48 continues to rotate in direction W, the belay device 2 assumes the position shown in FIG. 3a. This occurs at the latest after the coupling element 48, and due to the existing coupling also the rope pulley 14, has passed through a second predetermined movement section, the length of which is less than 360° or, if there are multiple stop elements 62, is determined by the angular arrangement of the stop elements 62.

In the position as is shown in FIG. 3a, a movement of the rope pulley 14 in direction W is prevented, and the blocking state is present. The further rotation of the coupling element 48 and, due to its coupling to the rotor 44, also the further rotation of the rope pulley 14 in direction W is limited by the impact of the stop surface 72r on the contact surface 64l.

In summary, in a securing case before the blocking state is assumed, the movement of the rope pulley 14 is limited by the movement of the coupling element 48. In a securing case the rope pulley 14 can therefore rotate until a stop element 62 completes a rotational movement that is less than 720° and, if there are multiple stop elements 62, in the securing case, the rope pulley 14 can rotate until an angular range has been passed that is smaller than the double maximum intermediate angle α between two stop elements 62.

To allow a free rotation of the rope pulley 14 in the free-running state of the blocking device, starting from the position shown in FIG. 3a, the belayer can pull the load end of the rope 16 towards the belay device 2, which causes a load change on the load end of the rope. This reduces the force with which the rotor 44 presses the at least one clamping element 46 into the inner toothed arrangement of the coupling element 48 to the extent that the elastic strap releases the at least one clamping element 46 out of the inner toothed arrangement, whereupon the at least one clamping element 46 slides back into the notch 54, releasing the coupling of the rotor to the coupling element 48. The rotor 44, and with it the rope pulley 14, can gain move freely. Since a force is no longer acting on the contact surface 64l in direction W, the movement of the coupling element 48 is no longer blocked.

Independent of the position of the control element, and thus of an influence being exerted by a belayer, or an actuation of the control element, the rotor 44 can again be coupled to the coupling element 48 if a securing case is detected, so that, depending on the direction of rotation, the case from FIG. 3a or FIG. 3b is present and there can be a blocking of the movement of the rope pulley 14 at the latest after passing through the predetermined movement section, in particular an angular interval. In a securing case the movement of the rope pulley 14 is thus limited to the predetermined movement section, which is smaller than the combination of the first and second predetermined movement section. This is ensured by the interaction between the stop element and the control element. In particular the provision of a cam section 66 on the stop element 62 and a cam guide surface 76 on the control element 40 ensures that the control element 40 assumes the blocked position at the latest after passing through the first predetermined movement section of the coupling element 48, and thus of the rope pulley 14, when the rotor 44 is coupled to the coupling element 48 via the at least one clamping element 46.

In other words, the control element 40 works like a catch in conjunction with the stop element 62: if the control element 40 is rotated counterclockwise out of the position shown in FIG. 3a, the stop element 62, which in FIG. 3a is in contact with the stop surface 72r, can rotate counterclockwise together with the coupling element 48. The blocking device therefore comprises a catch mechanism. The rotation of the coupling element 48 stops at the latest upon impact of the following stop element 62, because, as a result of the interaction of the cam section 66 of the stop element with the cam guide surface 76, the control element has again assumed its blocking position.

A blocking of the rope pulley 12 in the blocking state, as shown in FIG. 3a, can also be released by pulling on a belaying end of the rope 16 away from the belay device 2 in direction F, which causes a load change on the belaying end of the rope. This effects a rotation of the control element 40, which is the blocking position, in direction K3 about the second rotational axis 86 as a result of a lever effect of a force applied on the annular element 26 by the rope 16. The coupling element 48 is rotated clockwise via the contact of the stop surface 72r with the contact surface 64l. Such a small rotation is sufficient to relieve the pressure off the at least one clamping element 46 to such an extent that the elastic strap releases the at least one clamping element 46 out of the inner toothed arrangement of the coupling element 48, and the at least one clamping element 46 slides back into the notch 54. The rotor 44 is thus uncoupled from the coupling element 48 and the rope pulley 14 can rotate freely in the free-running state. Similarly, there is no longer a force acting on the contact surfaces 64l, 64r of the stop elements 62, so that a blocking of the coupling element 48 is released. In this process, which releases the blocking of the coupling element 48, the coupling of the rotor 44 to the coupling element 48 is preferably released at the same time. Most importantly, in this process the control element 40 is moved.

The function of the belay device 2 has been described with respect to the rotation direction W of the rope pulley 14. As a result of the symmetrical structure of the belay device 2, the function of the belay device 2 in the rotation direction opposite to the rotation direction W corresponds analogously to the function of the belay device 2 in the rotation direction W.

### SECOND EMBODIMENT

In the following only the differences of the second embodiment to the first embodiment will be discussed.

In the second embodiment, shown in FIGS. 4a and 4b, a braking device 106 is integrally configured on the housing 104 to reduce the weight of the belay device 102. The first section 168 of the control element exhibits an actuating section 192 that is separate from the braking device 106.

The actuating section 192 is preferably designed to be actuated by a belayer to move the control element.

The braking device 106 is configured as an annular element 126 with a slot 128, through which a rope loop can be pushed into the interior of the annular element 126. In doing so, a first rope end 184a preferably protrudes from the annular element 126 towards the top, while the second rope end 184b is passed around the rope pulley 114 by the user and then pushed through the slot 128 into the interior of the annular element 126. One of the half pulleys 142v can exhibit a recess 194 that is oriented in radial direction, so that the second rope end 184b can be pushed into the rope holding groove. This is advantageous in particular when a part of the rope pulley 114 is substantially flush with a section of the housing 104, as shown in FIG. 4b, to prevent an unintended sliding out the rope 116. The sliding out of the rope 116 can further be prevented by a closure element 130, which is preferably mounted to be displaceable with respect to the housing 104. The closure element 130 is preferably designed to close the slot 128. In a particularly preferred embodiment, the closure element 130 is designed to divide the interior space of the annular element 126 into two substantially closed grommets, whereby the first rope end 184a or the second rope end 184b respectively passes through one of these grommets.

The braking device 106 is disposed fixed in position with respect to a coupling point configured as the opening 178.

### THIRD EMBODIMENT

A third embodiment of the present invention is described in the following with reference to FIGS. 5 to 7, which is characterized in that at least one stop element 262 is directly disposed on the at least one clamping element 246, by means of which in the third embodiment of the present invention the clamping element 246 is configured contiguously, preferably integrally, with a coupling element. In the sense of the Claims, or several of the Claims, the clamping element 246 can be both a clamping element and a coupling element. The not visible edge of the holding groove 298 is indicated in FIG. 7 with a dotted line.

In the following only the differences to the embodiments 1 and 2 will be discussed. A belay device 202 of the third embodiment in particular has a symmetrical design with respect to a direction of use of a threaded rope.

The belay device 202 of the third embodiment of the present invention exhibits an annular element 226, a braking device 206, a rope holding element 212 configured as a rope pulley 214, and a base element 204. The braking device 206 exhibits at least one friction surface 232r, 232l, preferably two friction surfaces 232r and 232l. The friction surfaces 232r, 232l are able to brake a not depicted rope independent of the movement direction of the rope. Each of the friction surfaces 232r, 232l can be configured analogously to one of the friction surfaces 32r, 32l of the first design example. The stop element 262 exhibits a first contact surface 264r, a second contact surface 264l and a cam section 266.

The annular element 226 can exhibit two sub-elements 226l, 226r, which in a preferred embodiment are rotatably mounted on a common rotary shaft 286 on the base element 204. One of the sub-elements 226r of the annular element 226 is contiguously configured with a control element 240, whereby the sub-element 226r can comprise elements of the braking device 206. In a preferred embodiment, the control element 240 exhibits a cam guide surface 276, stop surfaces 272l, 272r and limiting tabs 274l, 274r. The rope pulley 214 can comprise a first half pulley 242v and a second half pulley 242h.

Preferably at least one holding groove 298, particularly preferably two holding grooves 298, are provided in a surface element 296 of the second half pulley 242h. The surface element 296 of the second half pulley 242h can also be considered to be a rotor. The surface element 296 can be a rotor in the sense of the Claims, or several of the Claims.

The surface element 296 can be contiguously configured with the second half pulley 242h, but the surface element 296 can also be manufactured separately and mounted to the second half pulley 242h by means of screws and/or rivets, so that the second half pulley 242h and the surface element 296 are connected to one another in a torque-proof manner. The belay device 202 preferably comprises two clamping elements 246. Each of these clamping elements is equipped with at least one, preferably two, guide pins 300l, 300r. The shape of a pin 300l, 300r is preferably adapted to the configuration of an associated holding groove 298. It is further preferred that at least one of the pins 300l, 300r, preferably both pins 300l, 300r, project into the associated holding groove 298.

In a particularly preferred embodiment, the at least one holding groove 298 exhibits an outer circumferential area 298out, which preferably extends along a circular section around a rotational axis 224 of the surface element 296.

The outer circumferential area 298out is preferably limited in each rotation direction by a blocking region 298rb, 298lb. A support assembly 302 can be provided between the blocking regions 298rb, 298lb on the side of the holding groove 298 across from the outer circumferential area 298out. The support assembly preferably comprises a left pin seat 298ls and a right pin seat 298rs. The region of the support assembly 302 between the left 298ls pin seat and the right 298rs pin seat preferably comprises a left 298lf and a right 298lf [sic] guide surface. The at least one holding groove 298 preferably exhibits a mirror symmetrical structure, whereby the mirror plane runs through the rotational axis 224. The clamping element 246 is preferably pretensioned by means of a spring assembly 304 in such a way that the pins 300l, 300r are resting in the respective pin seats 298ls, 298rs. If two clamping elements 246 are provided, the spring assembly 304 preferably couples the two clamping elements 246 to one another.

The surface element 296, the at least one clamping element 246 and the control element 240 are elements of a centrifugal clutch, as well as of a blocking device of the belay device 202. The braking device 206, in particular the friction surfaces 232r, 232l, is/are separate from the elements of the centrifugal clutch and/or the blocking device 208, in particular spaced and/or separate from movable elements of the centrifugal clutch and preferably fixed in position in relation to a coupling point 278 configured as a through hole.

The coupling point 278 is preferably configured in the base element 204, and is thus fixed in position in relation to the base element 204, which also preferably holds the rotational axis 224, or a shaft defining the rotational axis 224, in such a way that the rotational axis 224 is configured fixed in position in relation to the base element 204. This can in particular be achieved by configuring the shaft defining the rotational axis 224 to be fixed in position and/or torque-proof in relation to the base element 204. A shaft that is configured to be torque-proof in relation to the base element is to be understood as a shaft which cannot rotate relative to the base element. The shaft defining the rotational axis 224 preferably holds the rope pulley 214 in a rotatable manner. The rotational axis 224, or the shaft defining the rotational axis 224, is preferably disposed fixed in position in relation to the base element 204.

If the pins 300l, 300r are resting on the respective pin seats 298ls, 298rs, the blocking device 208 is a free-running state, in which it allows the movement of the rope pulley 214.

If the rope pulley 214 suddenly starts rotating in the direction of the arrow W, so that the acceleration of the rope pulley 214 (as a movement parameter of the rope pulley) lies outside the predetermined safety range of the acceleration assigned to the acceleration (which constitutes a securing case), a force F (indicated in FIG. 7 by means of arrows) resulting from the inertia of the at least one clamping element 246 acts on the right guide surface 298rf opposite to the direction W via the pin 300r. Since the guide surface 298rf is inclined in a radial direction R, and a component of the force F along the right guide surface 298rf thus points to the outside circumference of the rope pulley 214, the pin 300r slides along the right guide surface 298rf toward the outside circumference of the surface element 296. As soon as the pin 300r passes a flat area 306 of the support assembly 302 in its movement to the outside circumference of the surface element 296, the coupling element 246 moves substantially opposite to the rotation direction W until the pin 300l abuts in the blocking range 298lb. This movement of the clamping element 246 can be supported by an interaction of the at least one stop element 262 with the control element 240. As soon as the pin 300l comes to rest in the blocking region 298lb, the inertial force drives the pin 300r to the outer circumferential area 298out (if necessary supported by the interaction of the at least one stop element 262 with the control element 242), so that there is essentially a situation in which both pins 300l, 300r are resting on the outer circumferential area 298out and the pin 300r lies in a radial direction above that of the flat area 306.

If, on the other hand, the speed of the rope pulley 214 increases gradually, a centrifugal force drives the at least one clamping element 246 in the direction of the outside circumference of the surface element 296, until the two pins 300l, 300r hit the outer circumferential area 298out of the holding groove 298. This centrifugal force acts against the force exerted by the spring assembly, so that the two pins 300l, 300r do not hit the outer circumferential area 298out of the holding groove 298 until the rotational speed of the rope pulley 214 exceeds a limit speed, and thus lies outside the predetermined safety range of the rotational speed assigned to the rotational speed (as a movement parameter of the rope pulley) (which constitutes a securing case). If then the stop element 262 interacts with the control element 242, the pin 300l in the blocking region 298lb is moved, so that there is essentially a situation in which both pins 300l, 300r are resting on the outer circumferential area 298out and the pin 300r lies in a radial direction above that of the flat area 306.

For the action of coupling the at least one clamping element 246 to the control element 240, there can basically be two cases: Case 1), that the first limiting tab 274l in rotation direction W rests on the circumferential surface of the surface element 296, or Case 2), that the second limiting tab 274r in rotation direction W rests on the circumferential surface of the surface element 296.

In Case 1) the first contact surface 264r abuts against the stop surface 272l of the left limiting tab 274l and, since the pin 300l rests on the circumferential surface of the surface element 296 and, due to the position of the pin 300r above the flat area 306, the at least one coupling [sic] element 246 cannot deflect toward the rotational axis with respect to a radial direction of the surface element 296, the rotation (a movement) of the surface element 296 and, due to the torque-proof connection of the surface element 296 with the rope pulley 214, that of the rope pulley 214 as well, is blocked, without a stop element 262 having passed the control element 240 since the occurrence of the securing case. The action of the first contact surface 264r (an interaction) hitting the stop surface 272l can ensure the position of the pins 300l, 300r indicated in FIG. 7 with respect to the blocking range and the flat area 306.

In Case 2), on the other hand, there is a situation, in which the left limiting tab 274l is raised, so that a first stop element 288 passes the left limiting tab 274l and, with its cam section 266 and its contact surface 264r, the first stop element 288 cooperates with the cam guide surface 276 (an interaction), whereby the control element 240 is brought into a position so that, with its right contact surface 264r, a second stop element 290 abuts against the stop surface 272l of the left limiting tab 274l, which blocks a movement of the rope pulley 214 in a manner analogous to Case 1).

If the surface element 296, and thus the rope pulley 214, is blocked and the first contact surface 264r rests on the stop surface 272l, the movement of the at least one clamping element (coupling element) 246 is blocked. If the blocking of the rope pulley 214 or the surface element 296 is released, the blocking of the movement of the at least one clamping element (coupling element) 246 is released as well. If the limiting tab 274l is moved so far towards the surface element 296 that the contact surface 264r bumps against the stop surface 272l, the control element 240 transitions into its blocking position as soon as the contact surface 264r bumps against the stop surface 272l and the blocking device 208 subsequently transitions into the blocking position. If the left subsection 226l is rotated on the rotational axis 224 opposite to the direction Z, the control element 240 leaves its blocking position, and the blocking of the rope pulley 214 or the surface element 296 is released, whereby also the blocking of the at least one clamping element (coupling element) 246 is released.

Both at the end of the procedure described in Case 1) as well as that described in Case 2), there is a blocking state of the blocking device 208. The blocking state is in particular assumed at the latest during the movement of the second stop element in the area affected by the control element 240, so that the blocking device assumes the blocking state independent of an actuation of the control element 240 before the rope holding element 114 has run through a predetermined movement section. In the blocking state the movement of the clamping element (coupling element) 246 relative to the base element 204 is blocked, because the control element 240 preferably creates a force connection between the clamping element 246 and the base element 204 via the shaft 286 in the blocking state.

The blocking state sets in after the occurrence of a securing case independent of the position of the control element 240 that can be influenced by the user, or any other exertion of influence by the user.

Analogously to the first embodiment, the function of the blocking device in the third embodiment can be interpreted such that the control element 240 exhibits the function of a catch, and that the blocking device then correspondingly comprises a catch mechanism.

### Laying in the Rope

To lay the rope in, the sub-element 226r of the annular element 226 is rotated (flipped open) about the second axis 286 in the direction of the arrow Z, whereby a closure 308 between the right subsection 226r and the left subsection 226l is opened. At the same time a closure 310 on the other side between the left 226l and the right 226r sub-element of the annular element 226 is opened. Through these two openings, the rope can be threaded around the rope pulley in a later to be closed interior of the annular element 226. Once the rope is threaded in, the right sub-element 226r of the annular element 226 is rotated back opposite to the direction Z (flipped back), so that the two closures 308 and 310 are closed and the rope can no longer slide out of the interior of the annular element 226. In this case, the belay device 202 can be in a ready to secure state and the braking device 206 is preferably disposed substantially fixed in position with respect to the coupling point 278. The axis 286 preferably prevents a rope loop that has jumped out of the rope pulley 214 from sliding out of the interior space of the annular element 226. If the right sub-element 226r of the annular element 226 is pivoted downwards on the axis 286, at least the closure 308, preferably the closures 308 and 310, serves to transmit force to the left sub-element 226l of the annular element 226. If the left sub-element 226l is pivoted downwards on the rotational axis 268 [sic], at least the closure 310, preferably the closures 308 and 310, serves to transmit force to the left sub-element 226r.

A laid in rope can set the rope pulley 214 in motion.

### Releasing the Blocking State

A reduction of the force in the force transmission chain from the blocking region 298lb to the pin 300l via the at least one clamping element 246, its stop element 262 and the limiting tab 274l suffices to release the blocking state, so that the clamping element 246 is moved by the spring assembly 304 in such a way that the pins 300l, 300r slide back into the respective pin seats 298ls, 298rs, whereby the force transmission chain is interrupted, the blocking state is released and the blocking device transitions into the free-running state. The specific contact surfaces and a potentially existing support of the pin 300r on the flat area 306 were left out of the force transmission chain to increase legibility.

The release of the blocking device can occur in the following ways:
pressing down the sub-element 226r, which releases the contact of the contact surface 264r on the stop surface 272l of the left limiting tab 274l, while the stop surface 272l slides up due to the rotation of the sub-element 226r about the axis 286 and the above-described force transmission chain is interrupted and the at least one clamping element 246 is moved by the spring assembly 304 in such a way that the pins 300l, 300r slide back into the respective pin seats 298ls, 298rs.
pulling on the belaying end away from the belay device 202, whereby, as a result of the contact of the rope on the sub-element 226r, the sub-element 226r is pressed down as described above and the above-described force transmission chain is interrupted and the at least one clamping element 246 is moved by the spring assembly 304 in such a way that the pins 300l, 300r slide back into the respective pin seats 298ls, 298rs.
pulling on the load end towards the belay device 202, whereby, as a result of the contact of the rope on the rope pulley 214 and its torque-proof connection with the surface element 296, the force applied along the above-described force transmission chain is reduced to such an extent that the force applied to the at least one clamping element 246 by the spring assembly 304 suffices to move the at least one clamping element 246 in such a way that the pins 300l, 300r slide back into the respective pin seats 298ls, 298rs.

It should be noted that the two last points describe a load change on one end of the rope, which effect a release of a blocking of the clamping element 246 (coupling element).

Even though the function of the belay device has been described for a rotation in direction W, the function in the rotation direction opposite to direction W is analogous because of the symmetrical properties of the structure of the belay device 202. It should be noted here that a rotation of one of the sub-elements 226l, 226r is transmitted to the respective other of the sub-elements 226l, 226r by means of at least one of the closures 308, 310.

In a not depicted embodiment (to increase clarity, the reference signs already in use are also used in the following for this not depicted embodiment), a housing section can be provided on the side of the rope pulley 2014 [sic] lying across from the base element 204 the shaft 224 is preferably disposed on the housing section in a torque-proof manner and rotatably mounted in the base element 204. In this embodiment, the two sub-elements 226l, 226r (first and second sub-element) of the annular element 226 are preferably respectively rotatably mounted on one assigned first or second rotary shaft, which replaces the rotary shaft 286, whereby it is conceivable to rotatably mount the sub-element 226l to the base element 204 via the first rotary shaft and to rotatably mount the sub-element 226r on the housing section via the second rotary shaft. In this case the rotational axes defined by the shaft 224 and the second rotary shaft are fixed in relation to one another across the housing section. If now one or both of the sub-elements 226l, 226r is or are moved in such a way that the closures 308 and 310 open, the base element and the housing section can be rotated in relation to one another, whereby the first rotary shaft is displaced in relation to the second rotary shaft and the annular element 226 is flipped open. The annular element 226 can in particular be flipped open by displacing and/or rotating the first sub-element 226l and the second sub-element 226r in relation to one another. A rope can be pushed into this flipped open or generally open annular element 226 particularly easily, in particular through an opening in the annular element 226 that is created by opening the closure 308 or 310, or by the openings in the annular element 226 that are created by opening the closures 308 or 310. The base element 204 can be considered to be another housing section and, in the sense of this invention, the above-described housing section can be considered to be a base element.

### FOURTH EMBODIMENT

A fourth embodiment of the present invention, described in the following with reference to FIGS. 8a to 8e, is characterized in that the centrifugal clutch and the catch mechanism of the belay device 402 comprise two sections, whereby, upon exceedance of a speed or an acceleration of a rope pulley in a first rotation direction of the rope pulley (existence of a securing case), the first section of the centrifugal clutch effects a coupling of elements that leads to a blocking of the rope pulley, and does not effect a coupling of elements leading to a blocking of the rope pulley if the rope pulley exhibits a second rotation direction, opposite to the first rotation direction, even if upon rotation of the rope pulley in the second rotation direction there is the existence of a securing case; and, upon exceedance of a speed or an acceleration of a rope pulley in the other rotation direction of the rope pulley (existence of a securing case), the second section of the centrifugal clutch effects a coupling of elements that leads to a blocking of the rope pulley, and does not effect a coupling of elements leading to a blocking of the rope pulley if the rope pulley exhibits the first rotation direction, even if upon rotation of the rope pulley in the first rotation direction there is the existence of a securing case.

FIG. 8a shows a belay device 402, the structure of which is similar to that of the belay device 202, but is different with respect to the centrifugal clutch and the control element. Corresponding parts of belay device 202 are provided with same reference signs for belay device 402. To emphasize the functioning of the belay device 402, the representation of a housing or a base element has been omitted in FIGS. 8a to 8e.

Only the centrifugal clutch and the control element are discussed in the following, whereby the other elements and functions of the belay device 402 can correspond to those of the belay device 202. Modifications of elements of the belay device 202 of the third embodiment will be discussed separately.

FIG. 8a shows a first section of a centrifugal clutch of the belay device 402. The first centrifugal clutch section of the belay device 402 can comprise a blocking recess 404 and at least one flyweight 408, which is rotatably mounted on a shaft 406 and is provided with a switching tooth 410. The flyweight 408 can be pretensioned to a resting position via an elastic element, for example a spring 412 (for the sake of clarity indicated only in FIG. 8a). In the resting position there is the existence of a free-running state and the rope pulley 214 can rotate. The resting position can be defined by a contact of the flyweight 408 with a contact section 413, which can for example be configured as a bolt or an elevation. The blocking recess 404 and the shaft 406 are respectively disposed fixed in position in relation to the rope pulley 214 (the rope holding element). A blocking device of the belay device 402 comprises the centrifugal clutch and the rope pulley 214 as a rope holding element. The rope pulley 214 is rotatably mounted on a shaft 224.

The first section of the centrifugal clutch further preferably comprises a control element 416, which can be rotatably mounted on a shaft 414 on the annular element 226. The control element 416 is preferably pretensioned in a passive position shown in FIG. 8a, for example by a spring (not depicted).

The control element 416 can exhibit a catch 418 and/or a control element abutment surface 420 and/or a cam guide surface 422 and/or a switching tooth abutment surface 424. The annular element 226 can be modified to the extent that it exhibits a control element abutment counterface 426. The annular element 226 is preferably pivotably mounted on the shaft 414. The blocking device can therefore correspondingly comprise a catch mechanism.

The second section of the centrifugal clutch is disposed on the back side of the rope pulley 214 not depicted in FIG. 8a, and is preferably constructed to be mirror symmetrical to the first section of the centrifugal clutch in reference to a plane through the centers of the shaft 414 and the shaft 224, which are fixed in position relative to one another, so as to exhibit the same functionality (with reversed rotation directions of the components) in a rotation direction of the rope pulley 214 opposite to W.

If the rope pulley 214 rotates (moves) fast enough in direction W (first rotation direction), the centrifugal force drives the flyweight 408 against the force of the spring 412, preferably by a rotation about the shaft 406, in particular in direction S, into an active position that is shown in FIG. 8b.

If the rope pulley 214 is accelerated fast enough in direction W, the inertial force drives the flyweight 408 against the force of the spring 412, preferably by a rotation about the shaft 406, in particular in direction S, into an active position that is shown in FIG. 8b. In the active position, the flyweight 408 rests against an abutment element 434, by means of which a further rotation of the flyweight 408 in direction S is prevented. The abutment element 434 is configured fixed in position in relation to, and preferably in connection with, the rope pulley 214.

A securing case exists when the flyweight 408 is in the active position. If the flyweight 408 is in the active position and the rope pulley 214 continues to rotate in direction W, the switching tooth 410 abuts against the switching tooth abutment surface 424 (FIG. 8c) which effects a rotation of the control element 416 about the shaft 414 in direction P, as a result of which the catch 418 engages in the blocking recess 404. One flank 428 of the blocking recess 404 is preferably inclined in direction W in relation to a radial direction of the rope pulley 214, so that, upon engagement of the catch 418 in the blocking recess 404, a state is achieved in which the rotation (movement) of the rope pulley 214 is safely blocked, so that a blocking state exists, in which the rotation of the rope pulley 214 is blocked (stopped) and the movement of the rope is stopped. One flank 430 of the catch 418 (viewed while engaged in the blocking recess 404) is preferably inclined opposite to the direction W, and is in particular configured complementary to the flank 428 of the blocking recess 404.

At the same time, the control element abutment surface 420 engages on the control element abutment counterface 426, which effects a rotation of the annular element 226 in direction P. Furthermore, once the catch 418 has engaged in the blocking recess 404, the flyweight 408 can return to the resting position (FIG. 8d).

If, in the event of a securing case, the belayer pushes the annular element 226 down against the direction P, the control element abutment surface 420 engages on the control element abutment counterface 426 and the movement of the switching tooth 410 in direction W is stopped, which, due to the contact of the flyweight 408 on the abutment element 434, results in the rope pulley 214 being stopped. This is also to be considered a blocking state. Therefore, one of the blocking states occurs independent of an exertion of influence by a belayer.

If now, from this position shown in FIG. 8d, the annular element 226 is rotated opposite to the direction P by an action of a belayer, or by pulling downwards on a belaying end of a rope 432, the control element 416 rotates about the shaft 414 opposite to the direction P as a result of the control element abutment counterface 426 acting on the control element abutment surface 420. As a result, which can be accompanied by a rotation of the rope pulley 214 opposite to direction W, the engagement of the catch 418 in the blocking recess 404 is released and the rope pulley 214 can once again rotate. If the tension of the load end of the rope 432 is released or reduced, the pretension of the control element 416 in its passive position or a rotation of the rope pulley 214 opposite to the direction W (for example by pushing with the rope) can suffice to release the engagement of the catch 418 in the blocking recess 404, as shown in FIG. 8e. If the engagement of the catch 418 in the blocking recess 404 is released, the free-running state is restored.

Pulling on the belaying end or the reduction/release of the tension on the belaying end can be understood as load changes.

If, during a rotation of the rope pulley 214 opposite to the direction W (for example by a centrifugal or inertial force), the flyweight 408 is in the active position, the switching tooth 410 abuts against the cam guide surface 422 in the course of the rotation. The surface of the switching tooth 410 hitting the cam guide surface 422 is preferably configured in such a way, for example rounded off or inclined in W direction, that the abutment of the switching tooth 410 on the cam guide surface 422 triggers a movement of the flyweight 408 out of the active position, preferably a rotation about the shaft 406 opposite to the direction S, as a result of which the switching tooth 410 can slide through under the control element 416 opposite to the direction W.

As a result of the mirror symmetrical structure of the second section of the centrifugal clutch, this second section exhibits the same functionality for the W opposite rotation direction of the rope pulley 214 as the first section of the centrifugal clutch does for the rotation direction W.

If the speed or the acceleration of the rope pulley 214 (movement parameter of the rope holding element of a movement parameter set) lies above a limit value (outside a safety range of one of the movement parameters), so that a securing case exists, both the flyweight 408 of the first section of the centrifugal clutch as well as the not depicted flyweight of the second section of the centrifugal clutch are in the active position. Depending on the rotation direction of the rope pulley 214, there is either an engagement of the catch 418 in the blocking recess 404 in the first section of the centrifugal clutch, or there is an engagement of the catch in the blocking recess in the second section of the centrifugal clutch. The movement of the rope pulley 214 is thus blocked independent of a rotation direction, and thus of the movement direction of the guided rope, whereupon a movement of the rope is blocked. In the event of a securing case therefore, because a cooperation of the switching tooth 410 with the switching tooth abutment surface 424 preferably moves the catch 418 directly into the blocking recess 404, the movement of the rope pulley 214 is stopped at the latest after a rotation of the rope pulley by 360°, since by then at the latest the blocking device has assumed the blocking state.

The first section of the centrifugal clutch and the second section of the centrifugal clutch are preferably functionally independent of one another. This means, for example, that if the control element, whereby here control element preferably refers to the entire material section integrally connected with the control element, of the one (first or second) section of the centrifugal clutch is missing or defective, the function of the other section of the centrifugal clutch remains unaffected. The same can apply for the blocking recess and/or the flyweight of the one section of the centrifugal clutch, whereby again in particular the flyweight preferably refers to the entire material section integrally connected with the flyweight.

1.-20. (canceled)

21. A belay device (2; 102; 202, 402) comprising a braking device (6; 106; 206) and a blocking device (8; 108; 208),
whereby the blocking device (8; 108) comprises a movable rope holding element (12, 14; 112, 114; 212, 214), which is designed to be moved by a rope (16; 116) being held on it,
whereby the blocking device (8; 108) is designed in a blocking state to block a movement of the rope holding element (12, 14; 112, 114; 212, 214), whereby in a securing case the blocking device (8; 108, 208) transitions into the blocking state, whereby a securing case exists when a movement parameter of the movement of the rope holding element (12, 14; 112, 114; 212, 214) of a movement parameter set lies outside a predetermined safety range of the movement parameter assigned to the respective movement parameter,
wherein the braking device (6; 106; 206) is designed to brake a movement of the rope (16; 116) independent of a rope movement direction.

22. The belay device (2; 102; 202; 402) of claim 21,
whereby the blocking device (8; 108; 208) comprises a centrifugal clutch (10), and
whereby the braking device (6, 26; 106, 126; 206) is separately configured of movable parts of the centrifugal clutch (10).

23. The belay device (2; 102; 202; 402) of claim 21, wherein the movement parameter set comprises a speed and/or an acceleration as movement parameters of the movement of the rope holding element (12, 14; 112, 114; 212, 214).

24. The belay device (2; 102; 202; 402) of claim 21, wherein the blocking state occurs independent of an influence being exerted by a belayer.

25. The belay device (2; 102) of claim 21, further comprising
a base element (4),
whereby the rope holding element (12, 14; 112, 114) is configured as a rope pulley (14; 114), which is mounted to be rotatable relative to the base element (4), and whereby
the blocking device (8: 108) comprises a centrifugal clutch (10) comprising a rotor (44), a clamping element (46) and a coupling element (48), whereby
the rope pulley (12, 14; 112, 114) is coupled to or configured on the rotor in such a way that a rotation of the rope pulley (12, 14; 112, 114) effects a rotation of the rotor (44), and
whereby in the blocking state there is a coupling of the rotor (44) to the coupling element (48) by means of the clamping element (46) and/or whereby in the blocking state there is a blocking of a movement of the coupling element in relation to the base element.

26. The belay device (2; 102; 202; 402) of claim 21, wherein
to at least one of the movement parameters of the movement parameter set a predetermined safety range is assigned, which comprises values of the at least one movement parameter that characterize a movement of the rope holding element (12, 14; 112, 114; 212, 214) in a first direction, and which comprises values of the at least one movement parameter that characterize a movement of the rope holding element (12, 14; 112, 114; 212, 214) in a second direction, whereby the second direction is different from the first direction.

27. The belay device (2; 102; 202; 402) of claim 21, wherein the braking device (6; 106; 206) is configured separately from the blocking device (8; 108; 208).

28. The belay device (2; 102; 202; 402) of claim 21,
whereby the blocking device (8; 108; 208) is designed in a free-running state to allow the movement of the rope holding element (12, 14; 112, 114; 212, 214), whereby in the free-running state the braking device (6; 106; 206) is designed to brake the movement of the rope (16; 116; 432) independent of the rope movement direction.

29. The belay device (2; 102; 202; 402) of claim 21,
whereby, in a securing-ready state of the belay device (2; 102; 202; 402), the braking device (6; 106; 206) is disposed, substantially fixed in position, at a coupling point (78; 178; 278) of the belay device, which is provided on an external belay point for the purpose of coupling.

30. The belay device (2; 102; 202; 402) of claim 21, whereby the braking device (6; 106; 206) exhibits at least one friction surface (32r, 32l; 232r, 232l), preferably two friction surfaces (32r, 32l; 232r, 232l), for braking the rope (16; 116; 432).

31. The belay device (2; 102; 202; 402) of claim 21, whereby the braking device (6; 106; 206) is configured as an annular element (26; 126; 226).

32. The belay device (2; 102; 202; 402) of claim 21, wherein the braking device (6; 106; 206) is designed to flip open on the belay device (2; 102; 202; 406) for threading a rope (16; 116; 432).

33. The belay device (2; 102; 202; 402) of claim 21,
whereby the blocking device (8; 108; 208) is designed in a free-running state to allow the movement of the rope holding element (12, 14; 112, 114; 212, 214),
whereby the blocking device (8; 108; 208) is configured in such a way that a load change on one end (84r, 84l; 184r, 184l) of the rope effects a transition from the blocking state to the free-running state.

34. The belay device (2; 102; 202; 402) of claim 33, whereby the load change on a belaying end (84r, 84l; 184r, 184l) of the rope is effected by pulling on the belaying end (84r, 84l; 184r, 184l) away from the belay device (2; 102; 202; 402), and/or whereby the load change on a load end (84r, 84l; 184r, 184l) of the rope (16; 116; 432) is effected by pulling the load end (84r, 84l; 184r, 184l) towards the belay device (2; 102; 202; 402).

35. The belay device (2; 102; 202) of claim 21,
whereby the blocking device (8; 108; 208) is designed in a free-running state to allow the movement of the rope holding element (12, 14; 112, 114; 212, 214), whereby, in the securing case, the blocking device (8; 108; 208) transitions from the free-running state to the blocking state, whereby the blocking device (8; 108; 208) further exhibits a control element (40; 240), the actuation of which in the blocking state effects the transition of the blocking device (8; 108; 208) into the free-running state.
whereby, as soon as the securing case exists, the blocking device (8; 108; 208) assumes the blocking state independent of an actuation of the control element (40; 240), in particular by a belayer, before the rope holding element (12, 14; 112, 114; 212, 214) has run through a predetermined movement section.

36. A belay device (2; 102; 202, 402) comprising a braking device (6, 26; 106, 126; 206) and a blocking device (8; 108; 208),
whereby the blocking device (8; 108; 208) comprises a centrifugal clutch (10), and
whereby the braking device (6, 26; 106, 126; 206) is separately configured of movable parts of the centrifugal clutch (10).

37. The belay device (2; 102; 202; 402) of claim 36,
whereby the braking device (6; 26, 106, 126; 206) is configured as an annular element (26; 126).

38. The belay device (402) of claim 36,
whereby the blocking device comprises a movable rope holding element (214), which is designed to be moved by the rope (432) being held on it,
whereby the rope holding element (214) is coupled with the centrifugal clutch,
whereby the centrifugal clutch comprises a first and second section of the centrifugal clutch,
whereby the centrifugal clutch is designed in a blocking state to block a movement of the rope holding element (214) and to brake a movement of the rope (432),
whereby in a securing case the centrifugal clutch transitions into the blocking state,
whereby the securing case exists when a movement parameter of the movement of the rope holding element (214) of a movement parameter set lies outside a predetermined safety range of the movement parameter assigned to the respective movement parameter,
whereby the first section of the centrifugal clutch is designed in the event of a securing case to block a movement of the rope holding element (214) when the rope holding element (214) moves in a first direction, and is designed to allow the movement of the rope holding element when the rope holding element moves in a second direction, which is opposite to the first direction,
whereby the second section of the centrifugal clutch is designed in the event of a securing case to block the movement of the rope holding element (214) when the rope holding element (214) moves in the second direction, and is designed to allow the movement of the rope holding element when the rope holding element (214) moves in the first direction.

39. The belay device (2; 102; 202; 402) of claim 21, further comprising:
a base element (4); and,
a coupling point (78; 178; 278), which is provided on an external belay point for the purpose of coupling.
whereby the blocking device (8; 108; 208) comprises a movable rope holding element (12, 14; 112, 114; 212, 214), which is designed to be moved by a rope (16; 116) being held on it,
the rope holding element (12, 14; 112, 114) is configured as a rope pulley (14; 114, 214), which is mounted to be rotatable relative to the base element (4),
the coupling point (78; 178; 278) is configured to be stationary in relation to the base element (4), and
a rotational axis (24, 224) of the rope pulley (14; 114, 214) is configured to be stationary in relation to the base element (4).

40. The belay device of claim 21,
whereby the braking device is configured as an annular element, which is designed to flip open,
whereby the annular element preferably exhibits a first sub-element and a second sub-element, and
whereby particularly preferably the annular element is designed to be flipped open by displacing and/or rotating the first sub-element and the second sub-element relative to one another.
